(19) United States
(12) Patent Application Publication
(10) Pub. No.: US 2024/0027605 A1
(43) Pub. Date: Jan. 25, 2024

(54) METHOD FOR EXECUTION BY A SENSOR SYSTEM FOR A TRAFFIC INFRASTRUCTURE DEVICE, AND SENSOR SYSTEM

(71) Applicant: Continental Automotive Technologies GmbH, Hannover (DE)

(72) Inventors: Michael Goldhammer, Haibach (DE); Peter Quittenbaum, Bad Vilbel (DE)

(73) Assignee: Continental Automotive Technologies GmbH, Hannover (DE)

(21) Appl. No.: 18/042,461

(22) PCT Filed: Aug. 23, 2021
(86) PCT No.: PCT/DE2021/200114

§ 371 Date: Feb. 22, 2023

(30) Foreign Application Priority Data
Aug. 25, 2020 (DE) 10 2020 210 749.1

(51) Int. Cl. G01S 13/86; G01S 13/91; G01S 7/295; G08G 1/04; G08G 1/01

(52) U.S. Cl. CPC G01S 13/867; G01S 13/91; G01S 7/295; G08G 1/04; G08G 1/0116; G08G 1/0129

(57) ABSTRACT

A method of controlling a sensor system for a traffic infrastructure facility, by way of which a transformation rule for a coordinate transformation of radar data acquired by way of a radar device and of video data acquired by way of a video camera is determined based on an association of road users detected by way of the video camera with road users detected by way of the radar device.

### CROSS-REFERENCE TO RELATED APPLICATIONS

The present application is a National Stage Application under 35 U.S.C. § 371 of International Patent Application No. PCT/DE2021/200114, filed on Aug. 23, 2021, and claims priority from German Patent Application No. 10 2020 210 749.1 filed on Aug. 25, 2020, in the German Patent and Trade Mark Office, the disclosures of which are herein incorporated by reference in their entireties.

### BACKGROUND

### 1. Field

Embodiments of the present application relate to a method to be carried out by a sensor system for a traffic infrastructure facility and to a corresponding sensor system.

### 2. Description of Related Art

In the field of intelligent infrastructure systems for road traffic, high-performance camera and radar systems are being used more and more commonly. These enable the automatic detection and localization of vehicles and other road users in a wide detection area and thus allow a wide range of applications, such as the intelligent control of light signal installations and analysis for the longer-term optimization of traffic flow. Assistive functions for driver assistance systems and autonomous driving, in particular using wireless vehicle-to-X communication or, in this regard in particular, infrastructure-to-X communication, are currently under development.

If cameras and radars are used in parallel, it makes sense and, depending on the application, is even absolutely necessary to combine the data from both subsystems, that is to say to fuse said data. In order to associate the object data acquired in this way, it is generally necessary for a transformation rule between the individual sensors (“cross-calibration”) or between the sensors and another, jointly known coordinate system to be known, in particular in order to be able to associate the data from an object, such as for example a road user, detected in parallel by the camera and the radar with one another.

The sensors are in this case often calibrated using reference objects that are placed at measured positions in the field of view of the sensors and are able to be identified manually or automatically in the sensor data. For static positioning of reference objects, it is even necessary here in some cases to intervene in the current traffic flow; for example lanes or the entire road have to be temporarily closed.

As an alternative, comparatively easily identifiable static objects, for example bases of traffic signs, in the overlapping detection area of camera and radar may be marked manually and associated with one another. However, this requires such objects to be present in sufficient number in the overlapping field of view of the sensors and for them also to be clearly identifiable in the data from both sensor types. The road surface in particular normally does not offer any static objects able to be identified in the radar data.

The described methods therefore usually require comparatively extensive manual support for configuration, for example for the manual positioning of reference objects or for the marking of positions in the sensor data.

A high-quality and therefore cost-intensive system for determining the position of the reference objects in a global coordinate system, for example by way of differential GPS, is sometimes also required.

There is therefore the need for a solution that overcomes the stated disadvantages.

### SUMMARY

According to one embodiment of the method to be carried out by a sensor system for a traffic infrastructure facility, road users are detected by way of at least one video camera of the sensor system, which has a first detection area of the traffic infrastructure facility, and road users are detected by way of at least one radar device of the sensor system, which has a second detection area of the traffic infrastructure facility, wherein the first detection area and the second detection area at least partially overlap and detect at least one road having a plurality of lanes of the traffic infrastructure facility. A transformation rule for a coordinate transformation of data acquired by way of the radar device and of data acquired by way of the video camera is in this case determined on the basis of an association of road users detected by way of the video camera with road users detected by way of the radar device.

The association of road users detected by way of the video camera with road users detected by way of the radar device and the determination of the transformation rule takes place automatically here.

By way of example, the radar detection takes place in coordinates of a radar coordinate system, for example x-y coordinates, and the camera detection expediently takes place in a pixel grid or pixel coordinate system of the video camera. According to at least one embodiment, the transformation rule defines a coordinate transformation between a radar coordinate system in which the radar data are acquired and a camera coordinate system in which the video data are acquired and/or a coordinate transformation from the radar coordinate system and the camera coordinate system to a third coordinate system. In the case of the transformation to a third coordinate system, provision is made for transformation rules from the respective coordinate systems to the third coordinate system. Using the ascertained transformation rule, it is thus possible to associate objects or road users detected in one coordinate system and presumably identical objects or road users detected in the other coordinate system. The detected road users may in principle be displayed in the third coordinate system, which is different from the radar coordinate system and camera coordinate system, for further processing.

According to at least one embodiment, position information is acquired cumulatively over time from road users detected by way of the video camera and position information is acquired cumulatively over time from road users detected by way of the radar device. In this case, the detection takes place in particular on the basis of video data provided by the video camera or on the basis of radar data provided by the radar device. The result of the cumulative acquisition of the position information over time represents, in particular in each case for the radar data and the video data in the coordinate system in question, displayable composite movement profiles of the road users over the observation period. In other words, the lane profiles are identified through the cumulative detection of road user positions or detection of their movement profiles, wherein the acquired position information in particular relates initially to the respective coordinate system, camera coordinate system and/or radar coordinate system.

According to at least one embodiment, the respective lanes of the road are identified based on the position information acquired cumulatively over time by way of the video camera and, in parallel therewith, the respective lanes of the road are identified based on the position information acquired cumulatively over time by way of the radar device. The respective lanes are thus identified in the images from the video camera or on the basis of the video data and on the basis of the radar data, in particular independently of one another. The respective cumulative acquisition of the position information means that clear accumulations of detections are formed, in particular on the central axes of the lanes of the road. These maxima may accordingly be used to identify the respective roads.

According to at least one embodiment, ascertained maxima of the position information acquired cumulatively over time by way of the video camera and/or ascertained maxima of the position information acquired cumulatively overtime by way of the radar device are approximated by polylines, in particular splines. As already described, significant accumulations of detections usually form on the central axes of the lanes. According to this embodiment, ascertained maxima of these accumulations are approximated by polylines, which thus mathematically represent the lane profiles in the respective sensor coordinate systems.

According to one development, the cumulative acquisition of position information over time from road users detected by way of the video camera and/or the cumulative acquisition of position information over time from road users detected by way of the radar device takes place over a predefined and/or adjustable period. Adjustable in this sense is understood to mean in particular a manually changeably specifiable time interval and/or an automated adjustment of the period as a function of or until reaching a specified condition. The transformation rule or calibration may in particular be determined during current road traffic. There is no need for additional reference objects, and no reference positions measured with high precision are required. Provision may also be made for the automated determination of the transformation rule to be completed after a defined period, for example in the range from a few minutes to hours, and then to be used for the detection.

On the other hand, the calibration may also take place permanently or repeatedly during ongoing operation of the traffic infrastructure facility. This makes it possible to compensate for any changes that have occurred over time or to carry out constant optimization, for which purpose provision may be made in particular for a comparison of such a recalibration with a result of the original calibration or a previous calibration result. This makes it possible to establish automatic recognition of a misalignment of the sensors.

According to at least one embodiment, stopping positions of the road users with regard to the respective lanes are ascertained using the position information acquired cumulatively over time by way of the video camera and the position information acquired cumulatively over time by way of the radar device. The front stopping positions of the road users are in particular detected here. This is the case for example when the road users stop at a stop line at an intersection.

According to at least one embodiment, front stopping positions of the lanes are ascertained, wherein a maximum of the position information accumulated over time regarding the lane in question is ascertained. The maximum of the detection results here in particular from the stopping time at a location, which is longer in time compared to the detection of moving road users, and thus more frequent detection over a relevant period for this location. According to one development, provision may be made for this purpose to ascertain objects that are substantially immediately stationary in the lane in question if the speed of the objects is able to be ascertained. As an alternative or in addition, provision may be made for the local maxima closest to the video camera and/or to the radar device to be used as stopping position for the respective lanes. However, the prerequisite for this is the respective arrangement of the sensors and the corresponding detection area in the direction of the detected road with the closest stop lines. This procedure may also be used as a criterion or to support the discovery of a corresponding maximum in combination with at least one of the procedures described above, for example as the starting point for a corresponding search.

According to at least one embodiment, an association is made between the stopping positions ascertained by way of the video camera and the stopping positions ascertained by way of the radar device.

According to one development, for this purpose, a temporal occupancy of stopping positions identified based on the video data is in particular combined with stopping positions identified based on the radar data. This results in a number of possible associations that corresponds to the product of the number of identified stopping positions in the video data and the number of identified stopping positions in the radar data.

For the combination, for example, the respective binary occupancy state—vehicle at stopping position yes or no—may be combined over a certain time interval of for example a few minutes by way of an XNOR operation. An XNOR operation yields a 1 in the case of an identical state and a 0 in the case of a nonidentical state. Stopping positions for which a predefined minimum number of changes in the occupancy state (0→1, 1→0) are not reached during the predefined detection time are in particular ignored or the detection time is extended accordingly in order to ensure a sufficient statistical evaluation basis. The possible combinations may be sorted in particular according to time share or number of corresponding output values, and for example at least one association table containing the most probable associations of the stopping positions from the radar data and video data may be created therefrom.

One method that may be applied in addition or as an alternative and that is also particularly suitable for sensors that are able to supply non-binary or continuous data, such as for example the probability of occupancy of a stopping position, is that of considering cross-covariance. This may be determined as a crosswise degree of association between the various sensor outputs in order to establish the association of the stopping positions from the video data and radar data.

According to at least one embodiment, an association is made between the lanes identified by way of the video camera and the lanes identified by way of the radar device on the basis of the associated stopping positions of the road users.

According to one development, an association is made in this case between road users detected by way of the video camera and road users detected by way of the radar device taking into account the associated lanes.

According to at least one embodiment, for the identification of the lane profiles through cumulative detection of the road user positions, the road users detected by the video camera and the radar device are selected according to road users that are moving or have previously already moved and/or road users that have been classified as vehicle. For this purpose, it may prove expedient to use a classification of the detected road users in camera data and/or radar data or to receive correspondingly classified object data by way of the processing computing device.

According to at least one embodiment, the association between the stopping positions ascertained by way of the video camera and the stopping positions ascertained by way of the radar device is made by comparing detected times at which road users are located at the stopping positions and/or are moving to the stopping positions and/or leave the stopping positions. A comparatively clear case exists when for example only one road user on the road is detected by the radar device and the video camera. If said road user moves to an identified stopping position at a specific time, this stopping position may already basically be associated as being identical with regard to the detection by the radar device and the video camera. Since road users detected by way of the radar device and the video camera cannot in principle yet be associated and the situation might rarely prove to be so clear, provision is made in particular for a statistical evaluation of the times. It may be assumed here that, in reality, it is comparatively unlikely that road users will drive to a stopping position at identical times over a period under consideration. Over a period under consideration, as a result of even comparatively small time differences with regard to multiple road users driving through stopping positions, there are thus statistical possible associations for the stopping positions detected by way of the radar device and the video camera. The same applies to remaining at the stopping positions and leaving the stopping positions or when considering these events together.

According to at least one embodiment, the association is made between the lanes identified by way of the video camera and the lanes identified by way of the radar device on the basis of the associated stopping positions. This is thus effectively possible because the stopping positions form maxima of the lanes that have already been ascertained and are therefore associated directly therewith, and the association of the stopping positions of the various sensor coordinate systems thus enables the lanes to be associated.

According to at least one embodiment, an association is made between road users detected by way of the video camera and road users detected by way of the radar device taking into account the associated lanes in such a way that the road user detected by way of the radar device and that is located in a specific lane at a time closest to the stopping position corresponds to the road user detected by way of the video camera and that is located in the lane associated with this lane closest to the stopping position associated with this stopping position.

According to one development, provision may also be made to associate respective road users that are arranged second, third, etc. closest to the stopping positions. However, this may potentially result in a higher error rate, since (partial) occlusions by road users located closer to the stopping position in question may possibly lead to less precise detections of road users in question.

According to at least one embodiment, classification information provided by the radar device and/or the video camera is used to detect and/or associate and/or verify the association of the road users.

According to at least one embodiment, at least one associated pair of points in radar and camera coordinates is stored at at least one time in order to ascertain the transformation rule for at least one associated road user. In this case, a point represents a detected element in the coordinate systems, for example a pixel of the video camera and a measuring point in the case of the radar device. Over the period under consideration, there are thus two sets of points, each with a one-to-one associated (corresponding) point in the other set. According to one development, a homography matrix between a radar detection plane and a camera image plane is determined from the sets of points generated in this way. Homography is a projective transformation between the image coordinates of the video camera and the detection plane of the radar device, or a projective transformation between the image coordinates and the ground plane in front of the radar device. The second embodiment is particularly expedient when the mounting position, such as for example the height and angle of inclination of the radar device, is known.

According to at least one embodiment, at least one optimization method is used to avoid detection and association errors with the detected points, such as for example RANSAC. Since significantly more pairs of points are usually generated than are required for the homography calculation, for example four corresponding pairs of points, this also does not result in any worsening of the accuracy of the calculated transformation rule or the homography matrix.

Any distortion caused by the camera optics may in this case be considered to be negligible if it is able to be assessed as insignificant for the specific application and/or is able to be corrected in advance through an intrinsic calibration and/or is able to be ascertained directly from the generated pairs of points, for example by way of Bouguet's method.

According to at least one embodiment, the extrinsic calibration of the video camera is ascertained relative to the radar, wherein the corresponding pairs of points are considered as a perspective-n-point (PnP) problem. Such a problem may be solved for example by way of RANSAC, for example by way of Bouguet's method. The extrinsic calibration of the video camera describes in particular the precise position and orientation of the camera in space. The intrinsic camera parameters are expediently available for this purpose.

According to one development, provision may be made to use further information sources, in particular information received by way of vehicle-to-X communication, for determining the transformation rule.

According to an aspect of an embodiment, there is provided a sensor system for a traffic infrastructure facility, comprising at least one video camera having a first detection area of the traffic infrastructure facility and at least one radar device having a second detection area of the traffic infrastructure facility, wherein the first detection area and the second detection area at least partially overlap and detect at least one road having a plurality of lanes of the traffic infrastructure facility, wherein the sensor system is configured to carry out a method according to at least one of the described embodiments or developments of the described method.

According to at least one embodiment, the described sensor system comprises one or more computing devices for carrying out the method.

The disadvantages of existing solutions are able to be overcome with the proposed method and sensor system. In particular, a transformation rule between a camera coordinate system of a video camera and a radar coordinate system of a radar device of a traffic infrastructure facility may be ascertained automatically, as a result of which for example individual pixels of the video image are able to be associated with a counterpart in the radar data, or vice versa. The video data and the radar data are expediently available in the same time system for this purpose. The need for manual assistance may thereby be significantly reduced or avoided altogether, since for example manual marking of the data (what is known as labeling) is no longer necessary.

The sensor system is in particular a stationary sensor system for a traffic infrastructure facility. Such a sensor system is understood to mean in particular a sensor system that has been set up to be stationary for the relevant usage purpose for the respective traffic infrastructure facility. This is to be distinguished from sensor systems in particular the purpose of which is aimed at mobile use, for example in vehicles or by way of vehicles.

A traffic infrastructure facility is understood to mean for example a land-based, water-based or air-based traffic route such as for example a road, a railway track, a waterway, an air traffic route or an intersection of said traffic routes or any other traffic infrastructure facility that is suitable for transporting people or payload. The use of the sensor system for a road intersection, in particular with multiple feed lanes and their front stopping positions in the detection area of the sensors, has proven to be particularly advantageous.

A road user may for example be a vehicle, a cyclist or a pedestrian. A vehicle may be for example a motor vehicle, in particular a passenger vehicle, a truck, a motorcycle, an electric vehicle or a hybrid vehicle, a watercraft or an aircraft.

In one development of the specified sensor system, the specified system has a memory. In this case, the specified method is stored in the memory in the form of a computer program, and the computing device is provided for carrying out the method when the computer program is loaded into the computing device from the memory.

According to an aspect of an embodiment, there is provided a computer program comprises program code means in order to perform all of the steps of one of the specified methods when the computer program is executed by a computing device of the system.

According to an aspect of an embodiment, there is provided a computer program product contains a program code that is stored on a computer-readable data carrier and that, when executed on a data processing device, performs one of the specified methods.

### BRIEF DESCRIPTION OF THE DRAWINGS

The above and other aspects of the embodiments emerge from the following description, taken in conjunction with the drawings, in which:

In each case schematically:

FIG. 1 is a flowchart illustrating a method of radar control, according to an embodiment;

FIG. 2 is a flowchart illustrating a method of radar control, according to an embodiment;

FIG. 3A is a diagram illustrating a composite image accumulated over time formed of radar data from the detection area of the radar device, wherein the radar device, not shown, is arranged on the left in the image with a viewing direction to the right, according to an embodiment;

FIG. 3B is a diagram illustrating a composite image of a traffic intersection formed of radar data from multiple radar devices calibrated to one another in the same coordinate system, according to an embodiment;

FIG. 4 is a diagram illustrating the association of the front stopping positions of the road users, according to an embodiment;

FIG. 5 is a diagram illustrating the association of the lanes of the road users, according to an embodiment;

FIG. 6 is a diagram illustrating the association of the road users as such, according to an embodiment; and

FIG. 7 is a block diagram illustrating a sensor system, according to an embodiment.

### DETAILED DESCRIPTION

In order to allow a brief and simple description of the exemplary embodiments, essentially functionally identical elements are provided with the same reference signs.

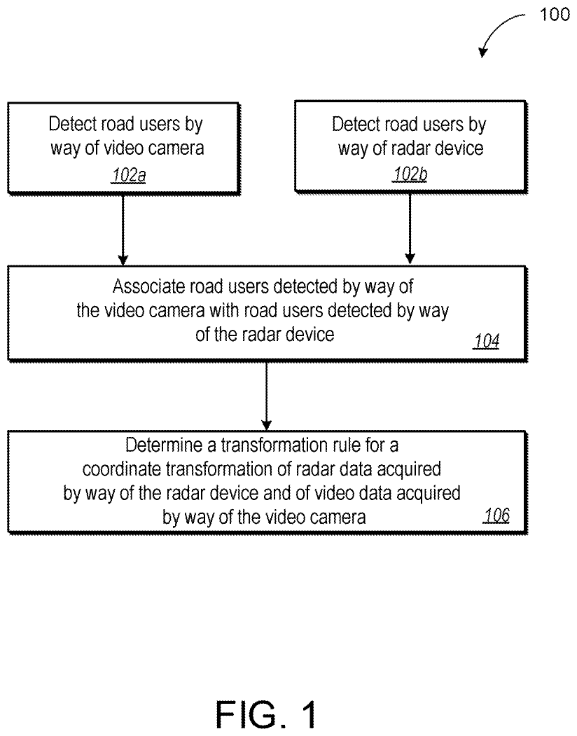

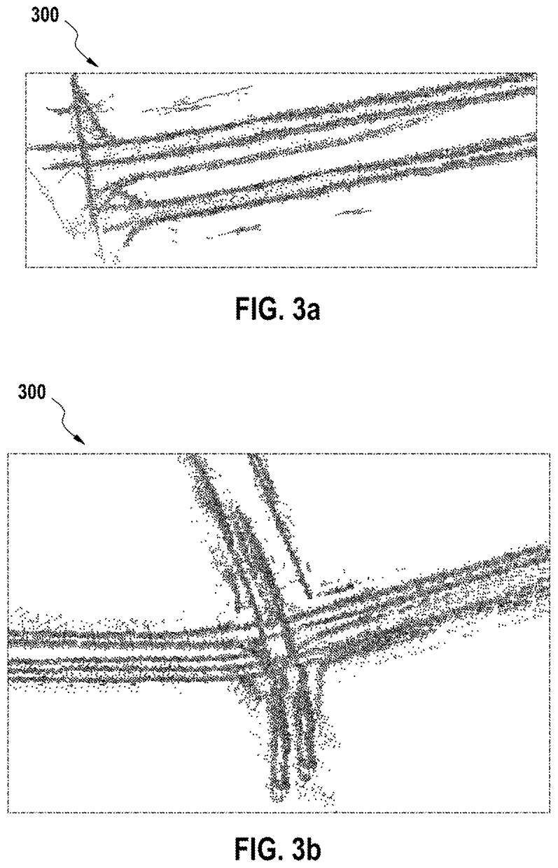

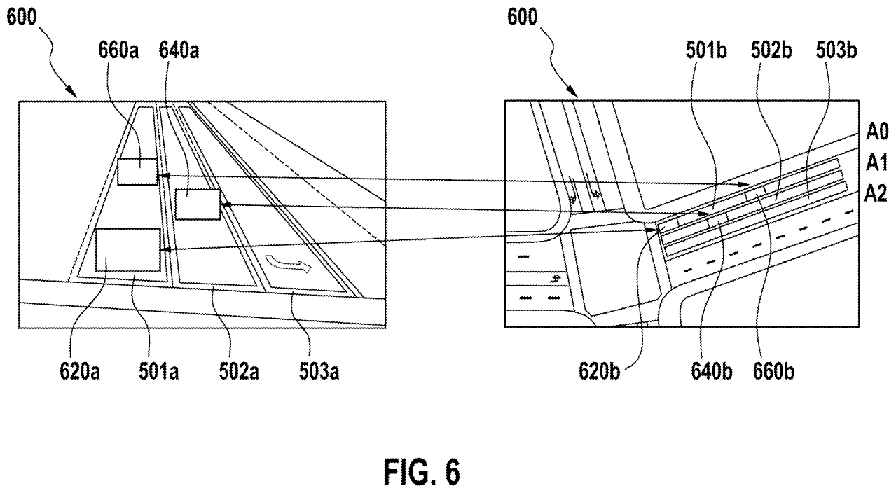

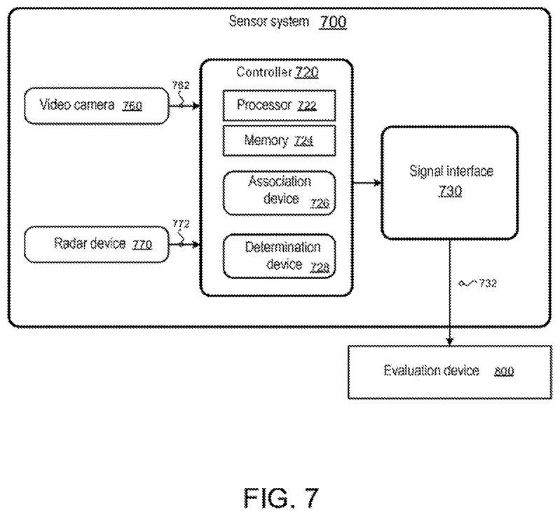

FIG. 1 shows one embodiment of the method 100 to be carried out by a sensor system 700, as described in one exemplary embodiment with reference to FIG. 7, for a traffic infrastructure facility 300, 400, 500 and 600 of FIGS. 3 to 6 using the example of a road traffic intersection. In a step 102a, road users 620, 640, 660 are detected by way of a radar device 770 of the sensor system 700 according to FIG. 7 having a first detection area of the traffic infrastructure facility 300, 400, 500 and 600 of FIGS. 3, 4, 5 and 6, and, separately from this, in a step 102b, road users 620, 640, 660 are detected by way of a video camera 760 of the sensor system 700 of FIG. 7 having a second detection area of the traffic infrastructure facility 300, 400, 500 and 600 of FIGS. 3, 4, 5 and 6, wherein the first detection area and the second detection area at least partially overlap and detect at least one road having a plurality of lanes of the traffic infrastructure facility 300, 400, 500 and 600. A transformation rule for a coordinate transformation of radar data acquired by way of the radar device 770 and of video data acquired by way of the video camera 760 is in this case determined on the basis of an association of road users 620, 640, 660 detected by way of the video camera 760 with road users 620, 640, 660 detected by way of the radar device 770.

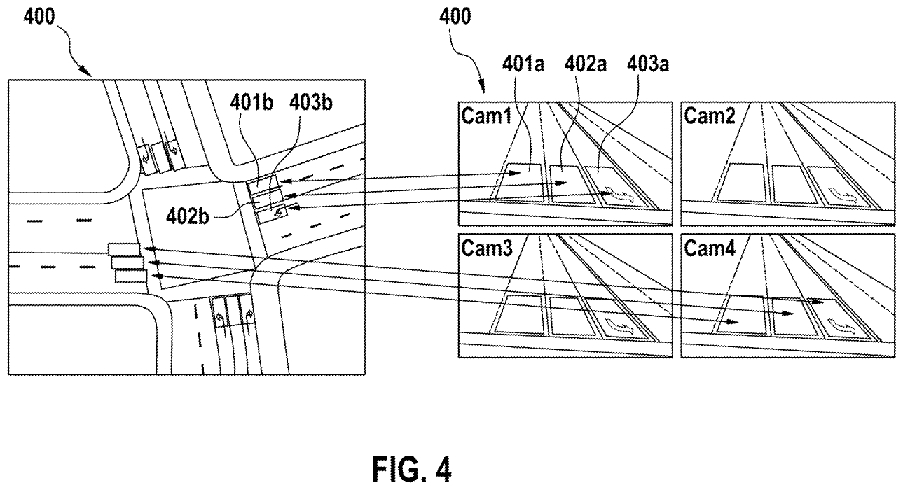

According to this exemplary embodiment, the radar detection takes place in x-y coordinates of the radar coordinate system, as shown in FIGS. 3A and 3B. The camera detection takes place, according to the example, in pixel coordinates (video image) of the video camera, as may be seen from the schematic illustrations in FIGS. 4, 5 and 6. According to at least one embodiment, the transformation rule determined by way of the method 100 and 200 defines a coordinate transformation between the radar coordinate system and the camera coordinate system in which the video data are acquired. As an alternative or in addition, the coordinate transformation takes place from the radar coordinate system and the camera coordinate system to a third coordinate system, in which the data are combined. Respective transformation rules from the respective coordinate systems to the third coordinate system are in particular provided for this purpose. Using the ascertained transformation rule, it is thus possible to associate objects or road users detected in one coordinate system and presumably identical objects or road users detected in the other coordinate system.

In a step 104, road users detected by way of the video camera are associated with road users detected by way of the radar device. This is understood to mean an association of identical road users in the video data and the radar data, regardless of which procedure is chosen for this purpose and what the starting point of the association is.

In a step 106, at least one pair of points in radar and camera coordinates is detected at at least one time in order to ascertain the transformation rule for at least one associated road user, thus resulting in two sets of points over a period under consideration, each having a one-to-one associated (corresponding) point in the other set. According to this example, a homography matrix is determined therefrom as transformation rule between the radar detection plane and the camera image plane. In addition, an optimization method, such as for example RANSAC, may be used to avoid detection and association errors with the detected points. Since significantly more pairs of points are usually generated than are required for the homography calculation, this also usually does not result in any worsening of the accuracy of the calculated transformation rule or the homography matrix.

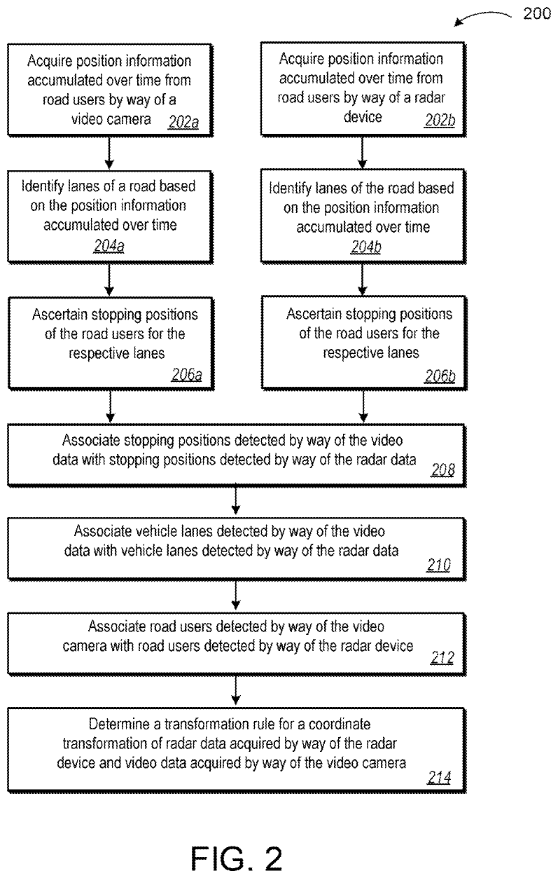

FIG. 2 shows a further embodiment of the method. In a step 202a, road users 620, 640, 660 are detected cumulatively over time by way of the radar device 770 having a first detection area of the traffic infrastructure facility 300, 400, 500 and 600 and, separately from this, in a step 202b, road users 620, 640, 660 are detected cumulatively over time by way of the video camera 760 having a second detection area of the traffic infrastructure facility 300, 400, 500 and 600, wherein the first detection area and the second detection area at least partially overlap and detect at least one road 320, 420, 520, 620 having a plurality of lanes of the traffic infrastructure facility 300, 400, 500 and 600.

In this case, the detection takes place in particular on the basis of video data 762 provided by the video camera 760 or on the basis of radar data 772 provided by the radar device 770. The result of the cumulative acquisition of the position information over time represents, in particular in each case for the radar data 772 and the video data 762 in the coordinate system in question, displayable composite movement profiles of the road users over the observation period. In other words, the lane profiles are identified through the cumulative detection of road user positions or detection of their movement profiles, wherein the acquired position information in particular relates initially to the respective coordinate system, camera coordinate system and/or radar coordinate system. The cumulative detection in FIGS. 3A and 3B for the radar detection is illustrated by way of example. FIG. 3A here shows the result of the detection by way of a single radar device 770 for an intersection arm and FIG. 3B shows the result of a fused detection of multiple radar devices for the entire intersection.

According to one development, the cumulative acquisition of position information over time from road users detected byway of the video camera 760 and/or the cumulative acquisition of position information over time from road users detected by way of the radar device 770 takes place over a predefined and/or adjustable period. Adjustable in this sense is understood to mean in particular a manually changeably specifiable time interval and/or automated adjustment of the period as a function of or until reaching a specified condition, for example a quality level of the detection.

In a step 204a, the respective lanes of the road are identified based on the position information acquired cumulatively over time by way of the video camera 760 and, in parallel therewith, in step 204b, the respective lanes of the road are identified based on the position information acquired cumulatively over time by way of the radar device 770. The respective lanes are thus identified in the images from the video camera 760 or on the basis of the video data 762 and on the basis of the radar data 772 from the radar device 770, in particular independently of one another. The respective cumulative acquisition of the position information means that clear accumulations of detections are formed, in particular on the central axes of the lanes of the road. These maxima may accordingly be used to identify the respective roads.

According to at least one embodiment, for the identification of the lane profiles through cumulative detection of the road user positions, the road users detected by the video camera and the radar device are selected according to road users that are moving or have previously already moved and/or road users that have been classified as vehicles. For this purpose, it may prove expedient to use a classification of the detected road users in camera data and/or radar data or to receive correspondingly classified object data by way of the processing computing device.

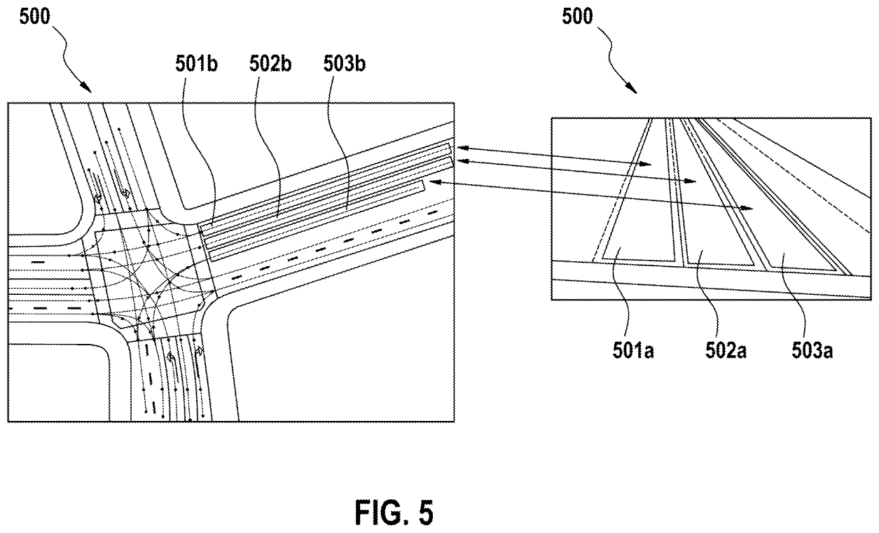

According to at least one embodiment, ascertained maxima of the position information acquired cumulatively over time by way of the video camera and/or ascertained maxima of the position information acquired cumulatively overtime byway of the radar device are approximated by polylines, in particular splines. As already described, significant accumulations of detections usually form on the central axes of the lanes. According to this embodiment, these ascertained maxima are approximated by polylines, which thus mathematically represent the lane profiles in the respective sensor coordinate systems. One example of a result of a polyline approximation in this regard may be seen in the left-hand partial image in FIG. 5, which was generated on the basis of the video data.

In a step 206a, stopping positions of the road users with regard to the respective identified lanes are ascertained separately using the position information acquired cumulatively over time by way of the video camera 760 and the position information acquired cumulatively over time by way of the radar device 770. The front stopping positions of the road users are in particular detected here. This is the case for example when the road users stop at a stop line at an intersection.

According to at least one embodiment, to ascertain the front stopping positions of the lanes, a maximum of the position information accumulated over time regarding the lane in question is ascertained. The maximum of the detection results here in particular from the stopping time at a location, which is longer in time compared to the detection of moving road users, and thus more frequent detection over a relevant period for this location. According to one development, provision may be made for this purpose to ascertain objects that are substantially immediately stationary in the lane in question if the speed of the objects is able to be ascertained. As an alternative or in addition, provision may be made for the local maxima closest to the video camera 760 and/or to the radar device 770 to be used as stopping position for the respective lanes. However, the prerequisite for this may be the respective arrangement of the sensors and the corresponding detection area in the direction of the detected road with the closest stop lines. This procedure may also be used as a criterion or to support the discovery of a corresponding maximum in combination with at least one of the procedures described above, for example as the starting point for a corresponding search.

In a step 208, an association, illustrated by corresponding arrows, is made between the stopping positions 401a, 402a, 403a ascertained by way of the video camera 760 or video data 762, as illustrated in FIG. 4, and the stopping positions 401b, 402b, 403b ascertained by way of the radar device 770 or radar data 772, as likewise illustrated in FIG. 4. This is shown in FIG. 4 using the example of detection Cam1 to Cam 4 of an intersection by four video cameras and four radar devices. For the sake of clarity, the other stopping positions that are illustrated have not been identified by reference signs. According to one development, for this purpose, a temporal occupancy of stopping positions identified based on the video data 762 is in particular combined with stopping positions identified based on the radar data 772. This results in a number of possible associations that corresponds to the product of the number of identified stopping positions from the video data 762 and the number of identified stopping positions from the radar data 772.

According to at least one embodiment, the association between the stopping positions ascertained by way of the video data 762 and the stopping positions ascertained by way of the radar data 772 is made by comparing detected times at which road users are located at the stopping positions and/or are moving to the stopping positions and/or leave the stopping positions.

For the combination, for example, the respective binary occupancy state—vehicle at stopping position yes or no—may be combined over a certain time interval of for example a few minutes by way of an XNOR operation. An XNOR operation yields a 1 in the case of an identical state and a 0 in the case of a nonidentical state. Stopping positions for which a predefined minimum number of changes in the occupancy state (0→1, 1→0) are not reached during the predefined detection time are in particular ignored or the detection time is extended accordingly in order to ensure a sufficient statistical evaluation basis. The possible combinations may be sorted in particular according to time share or number of corresponding output values, and for example at least one association table containing the most probable associations of the stopping positions from the radar data and video data may be created therefrom.

One method that may be applied in addition or as an alternative and that is also particularly suitable for sensors that are able to supply non-binary or continuous data, such as for example the probability of occupancy of a stopping position, is that of considering cross-covariance. This may be determined as a crosswise degree of association between the various sensor outputs in order to establish the association of the stopping positions from the video data and radar data.

In a step 210, an association, illustrated by corresponding arrows, is made between the lanes 501a, 502a, 503a identified by way of the video data 762 and the lanes 501b, 502b, 503b identified by way of the radar data 772 on the basis of the associated stopping positions of the road users, as illustrated in FIG. 5, wherein, in comparison to FIG. 4, the association for the detection is shown only by a video camera 760 and a radar device 770. According to one development, an association is made in this case between road users detected by way of the video camera 760 and road users detected by way of the radar device 770 taking into account the associated lanes. This is thus effectively possible because the stopping positions form maxima of the lanes that have already been ascertained and are therefore associated directly therewith, and the association of the stopping positions of the various sensor coordinate systems thus enables the lanes to be associated.

In a step 212, an association is made between road users 620a, 640a, 660a detected by way of the video camera 760 and road users 620b, 640b, 660b detected by way of the radar device 770 taking into account the associated lanes in such a way that the road user detected by way of the radar device 770 and that is located in a specific lane at a time closest to the stopping position corresponds to the road user detected by way of the video camera 760 and that is located in the lane associated with this lane closest to the stopping position associated with this stopping position. According to one development, provision may also be made to associate respective road users that are arranged second, third, etc. closest to the stopping positions.

In a step 214, the transformation rule for the coordinate transformation of radar data 772 acquired by way of the radar device 770 and of video data 762 acquired by way of the video camera 760 is determined, for example as already described for the exemplary embodiment with reference to FIG. 1, based on an association of the road users 620a, 640a, 660a detected by way of the video camera 760 with road users 620b, 640b, 660b detected by way of the radar device 770. With the automatically determined transformation rule, road users detected separately with the video camera 660 and the radar device 670 may in particular subsequently be associated with one another, and their position information may for example be converted to a matching coordinate system.

FIG. 7 shows one embodiment of the sensor system for a traffic infrastructure facility, comprising at least one video camera 760 having a first detection area of the traffic infrastructure facility and at least one radar device 770 having a second detection area of the traffic infrastructure facility, wherein the first detection area and the second detection area at least partially overlap and detect at least one road having a plurality of lanes of the traffic infrastructure facility, wherein the sensor system is configured to carry out a method according to at least one of the described embodiments or developments of the described method, for example as described with reference to FIG. 1 and FIG. 2.

According to at least one embodiment, the described sensor system 700 comprises one or more computing devices, such as for example a controller 720, for carrying out the method. The controller 720 comprises, according to the example, a processor 722 and a data memory 724. In addition, the exemplary embodiment of the sensor system 700 comprises an association device for associating road users detected by the video camera 760 with road users detected by the radar device 770. The sensor system furthermore comprises a determination device 728 for determining a transformation rule for a coordinate transformation of radar data 772 acquired by way of the radar device 770 and of video data 762 acquired by way of the video camera 760. The controller 720 is able to output processed data to a signal interface 730 for transmission to an evaluation device 800 or receive data from the evaluation device.

The proposed method and sensor system allow in particular a transformation rule between a camera coordinate system of the video camera 760 and a radar coordinate system of the radar device 770 of a traffic infrastructure facility to be ascertained automatically, as a result of which for example individual pixels of the video image are able to be associated with a counterpart in the radar data, or vice versa. The video data 762 and the radar data 772 are expediently available in the same time system for this purpose. This makes it possible to improve the automatic detection and localization of vehicles and other road users, in particular through intelligent infrastructure facilities for the intelligent control of light signal installations and analysis for the longer-term optimization of traffic flow.

If it is found in the course of the proceedings that a feature or a group of features is not absolutely necessary, then the applicant aspires right now to a wording of at least one independent claim that no longer has the feature or the group of features. This may be, for example, a subcombination of a claim present on the filing date or a subcombination of a claim present on the filing date that is restricted by further features. Claims or combinations of features of this kind requiring rewording are intended to be understood as also covered by the disclosure of this application.

It should also be pointed out that refinements, features and variants of the embodiments which are described and/or shown in the figures may be combined with one another in any desired manner. Single or multiple features are interchangeable with one another in any desired manner. Combinations of features arising therefrom are intended to be understood as also covered by the disclosure of this application.

Back-references in dependent claims are not intended to be understood as a relinquishment of the attainment of independent substantive protection for the features of the back-referenced dependent claims. These features may also be combined with other features in any desired manner.

Features which are only disclosed in the description or features which are only disclosed in the description or in a claim in conjunction with other features may in principle be of independent significance essential to the embodiments. They may therefore also be individually included in claims for the purpose of delimitation from the prior art.

In general, it should be pointed out that vehicle-to-X communication is understood to mean in particular a direct communication between vehicles and/or between vehicles and infrastructure facilities. For example, it may thus include vehicle-to-vehicle communication or vehicle-to-infrastructure communication. Where this application refers to a communication between vehicles, said communication may fundamentally take place as part of a vehicle-to-vehicle communication, for example, which is typically effected without switching by a mobile radio network or a similar external infrastructure and which must therefore be distinguished from other solutions based on a mobile radio network, for example. By way of example, a vehicle-to-X communication may be implemented using the IEEE 802.11p or IEEE 1609.4 standards. A vehicle-to-X communication may also be referred to as C2X communication or V2X communication. The sub-domains may be referred to as C2C (car-to-car), V2V (vehicle-to-vehicle) or C2I (car-to-infrastructure), V2I (vehicle-to-infrastructure). However, the embodiment explicitly does not exclude vehicle-to-X communication with switching via a mobile radio network, for example.

Various implementations of the systems and techniques described here may be implemented in digital electronic circuitry, in integrated circuits, specially designed ASICs (application-specific integrated circuits), computer hardware, firmware, software, and/or combinations thereof. These various implementations may include the implementation in one or more computer programs able to be executed and/or interpreted on a programmable system, including at least one programmable processor, which may have a special or general purpose, coupled with the receipt of data and instructions from a storage system, at least one input device and at least one output device and the transmission of data and instructions to a storage system.

These computer programs (also called programs, software, software applications or code) contain machine instructions for a programmable processor and may be implemented in high-level procedural and/or object-oriented programming language and/or in assembly/machine language. The terms “machine-readable medium” and “computer-readable medium” as used here refer to any computer program (for example magnetic disks, optical data carriers, memories, PLC) used to provide machine instructions and/or data to a programmable processor, including a machine-readable medium containing machine instructions in the form of a machine-readable signal. The term “machine-readable signal” refers to any signal used to provide machine instructions and/or data to a programmable processor.

The implementations of the subject matter and of the functional processes described in this specification may be implemented in digital electronic circuitry or in computer software, firmware or hardware, including the structures specified in this specification and their structural counterparts, or in combinations of one or more thereof. Furthermore, the contents described in this specification may be implemented as one or more computer program products, that is to say one or more modules of computer program instructions encoded on a computer-readable data carrier, for execution by or for controlling the operation of data processing devices. The computer-readable medium may be a machine-readable storage device, a machine-readable storage substrate, a storage device, a material structure that initiates a machine-readable propagation signal, or a combination of one or more thereof. The terms “data processing devices”, “computing device” and “computing processor” comprise all data processing devices, equipment and machines, for example a programmable processor, a computer or multiple processors or computers. In addition to hardware, the device may also contain code that creates an execution environment for the computer program in question, for example code representing processor firmware, a protocol stack, a database management system, an operating system, or a combination of one or more thereof. A propagated signal is an artificially generated signal, for example a machine-generated electrical, optical or electromagnetic signal generated in order to encode information for transmission to suitable receiver devices.

A computing device may in this case be any device that is designed to process at least one of said signals. In particular, the computing device may be a processor, for example an ASIC, an FPGA, a digital signal processor, a central processing unit (CPU), a multi-purpose processor (MPP) or the like.

Even though the processes are illustrated in a specific order in the drawings, this should not be understood to mean that such processes have to be performed in the stated order or in a sequential order, or that all illustrated processes have to be performed in order to achieve desirable results. In some circumstances, multitasking and parallel processing may be advantageous. In addition, the separation of various system components in the embodiments described above should not be understood to mean such a separation in all embodiments, and it should be understood that the described program components and systems may generally be integrated into a single software product or packaged into multiple software products.

A number of implementations have been described. However, it is assumed that various modifications may be made without departing from the spirit and scope of the disclosure. Other implementations accordingly fall within the scope of the following statements.

A number of implementations have been described. However, it is assumed that various modifications may be made without departing from the spirit and scope of the disclosure. Other implementations accordingly fall within the scope of the following statements.

1. A method of controlling a sensor system for a traffic infra-structure facility, the method comprising:
detecting road users are detected by at least one video camera of the sensor system within a first detection area of the sensor system;
detecting the road users by at least one radar device of the sensor system within a second detection area of the radar device, wherein the first detection area and the second detection area at least partially overlap at least one road having a plurality of lanes of the traffic infrastructure facility;
determining a transformation rule for a coordinate transformation of radar data acquired by the radar device and video data acquired by the video camera on the basis of an association of road users detected by the video camera with road users detected by the radar device; and
associating the road users detected according to the radar data of the radar device in a first coordinate system of the radar device and the road users detected according to the video data of the video camera in a second coordinate system of the video camera using the transformation rule.

2. The method as claimed in claim 1, further comprising:
acquiring position information cumulatively over time from the road users detected by the video camera;
accruing position information cumulatively over time from the road users detected by the radar device; and
identifying the respective lanes based on the position information acquired cumulatively over time by the video camera and the position information acquired cumulatively over time by the radar device.

3. The method as claimed in claim 2, further comprising:
determining stopping positions of the road users with regard to the respective lanes using the position information acquired cumulatively over time by the video camera and the position information acquired cumulatively over time by the radar device; and
determining an association between the stopping positions ascertained by the video camera and the radar device.

4. The method as claimed in claim 3, further comprising:
determining an association between the lanes identified by the video camera and by the radar device on the basis of the associated stopping positions; and
associating the road users detected by the video camera and the road users detected by the radar device based on the associated lanes.

5. The method as claimed in claim 1, wherein detecting the road users by the video camera and the radar device comprises selecting the road users according to movement of the road users.

6. The method as claimed in claim 2, wherein acquiring the position information over time from road users detected by the video camera and by the radar device takes place over a period of time.

7. The method as claimed in claim 6, further comprising approximating ascertained maxima of the position information acquired over time by the video camera and ascertained maxima of the position information acquired over time by the radar device based on polylines.

8. The method as claimed in claim 7, further comprising determining front stopping positions of the lanes and a maximum of the position information accumulated over time regarding the lane.

9. The method as claimed in claim 8, further comprising determining an association between the stopping positions ascertained by the video camera and the radar device by comparing detected times at which road users are located at the stopping positions and are moving to the stopping positions and leave the stopping positions.

10. The method as claimed in claim 1, wherein determining the transformation rule comprises:
determining at least one associated pair of points in radar and camera coordinates to ascertain the transformation rule for at least one associated road user; and
determining a homography matrix between a radar detection plane and a camera image plane from a plurality of pairs of the points.

11. (canceled)
